(19) United States
(12) Patent Application Publication
(10) Pub. No.: US 2013/0106213 A1
(43) Pub. Date: May 2, 2013

(54) SPINDLE MOTOR AND METHOD OF MANUFACTURING THE SAME

(71) Applicant: SAMSUNG ELECTRO-MECHANICS CO., LTD., Suwon (KR)

(72) Inventor: Sung Bu JO, Suwon (KR)

(73) Assignee: SAMSUNG ELECTRO-MECHANICS CO., LTD., Suwon (KR)

(21) Appl. No.: 13/653,985

(22) Filed: Oct. 17, 2012

(30) Foreign Application Priority Data
Nov. 1, 2011 (KR) 10-2011-0112694

(51) Int. Cl. H02K 7/00; B29C 65/52

(52) U.S. Cl. 310/66; 156/294

(57) ABSTRACT

There is provided a spindle motor including: a sleeve rotatably supporting a shaft and having an adhesive receiving groove formed in a lower end portion thereof; and a cover member installed on the lower end portion of the sleeve and having a coupling part insertedly coupled to the adhesive receiving groove, wherein the coupling part is disposed so as to be immersed in an adhesive filling the adhesive receiving groove.

### CROSS-REFERENCE TO RELATED APPLICATIONS

This application claims the priority of Korean Patent Application No. 10-2011-0112694 filed on Nov. 1, 2011, in the Korean Intellectual Property Office, the disclosure of which is incorporated herein by reference.

### BACKGROUND OF THE INVENTION

1. Field of the Invention

The present invention relates to a spindle motor and a method of manufacturing the same.

2. Description of the Related Art

A small spindle motor used in a hard disk drive (HDD) is generally provided with a fluid dynamic pressure bearing assembly, a bearing clearance formed between a shaft and a sleeve of the fluid dynamic pressure bearing assembly is filled with a lubricating fluid such as oil. The oil filling the bearing clearance generates fluid dynamic pressure while being compressed at the time of rotation of the shaft, thereby rotatably supporting the shaft.

Meanwhile, the fluid dynamic bearing assembly is formed by coupling a plurality of components to each other, and the bearing clearance formed by the plurality of components is filled with a lubricating fluid. However, a gap may be formed in a portion where the plurality of components are coupled to each other. Therefore, the lubricating fluid filling the bearing clearance may be leaked from the bearing clearance through the gap.

In this case, a defect may be generated in the driving of the spindle motor. Therefore, it is important to prevent the lubricating fluid from being leaked through the gap formed between the components.

Meanwhile, the sleeve includes a cover plate installed on a lower end portion thereof in order to prevent the lubricating fluid from being leaked to the lower end portion thereof. In addition, the sleeve and the cover plate are adhered to each other by an adhesive in order to prevent the lubricating fluid from being leaked through the gap formed in the coupled portion between the cover plate and the sleeve.

However, the adhesive applied in order to adhere the sleeve and the cover plate to each other may be introduced into the bearing clearance, such that it may be mixed with the lubricating fluid.

In this case, the purity of the lubricating fluid is deteriorated, such that rotational characteristics of the rotor may be deteriorated.

In order to prevent this problem, the adhesive is primarily applied to the sleeve before the cover plate is installed, the cover plate is simply adhered to the sleeve, and the adhesive is then secondarily applied to the cover plate and the sleeve to thereby bond and install the cover plate to the sleeve.

In this case, since a process of applying an adhesive is repeatedly performed, manufacturing efficiency is reduced. Moreover, a process of hardening an adhesive is repeatedly performed, and the adhesive is introduced in the case in which the adhesive is not sufficiently hardened, such that the adhesive may be mixed with the lubricating fluid.

### SUMMARY OF THE INVENTION

An aspect of the present invention provides a spindle motor in which a cover member and a sleeve may be easily manufactured, and a method of manufacturing the same.

Another aspect of the present invention provides a spindle motor having improved coupling strength between a cover member and a sleeve, and a method of manufacturing the same.

Another aspect of the present invention provides a spindle motor capable of suppressing contamination at the time of coupling a cover member and a sleeve, and a method of manufacturing the same.

According to an aspect of the present invention, there is provided a spindle motor including: a sleeve rotatably supporting a shaft and having an adhesive receiving groove formed in a lower end portion thereof; and a cover member installed on the lower end portion of the sleeve and having a coupling part insertedly coupled to the adhesive receiving groove, wherein the coupling part is disposed so as to be immersed in an adhesive filling the adhesive receiving groove.

The cover member may include: a disk part having a disk shape; an inclined part extended to be inclined upwardly from the disk part; and the coupling part extended from the inclined part in an outer radial direction.

The sleeve may include an extension wall part formed at an edge of a lower surface thereof, wherein the extension wall part contacts an outer peripheral surface of the coupling part.

The adhesive receiving groove may have a depth allowing the coupling part to be insertedly disposed in an inner portion thereof.

An inner surface of the adhesive receiving groove may be inclined so as to correspond to the inclined part.

The adhesive receiving groove may include a guide groove formed in an outer surface thereof, the guide groove guiding an amount of the adhesive.

According to another aspect of the present invention, there is provided a method of manufacturing a spindle motor, the method including: preparing a sleeve such that a lower surface of the sleeve having an adhesive receiving groove formed therein is disposed to be directed upwardly; filling the adhesive receiving groove with an adhesive; and bonding a cover member to the sleeve such that a coupling part of the cover member is immersed in the adhesive filling the adhesive receiving groove.

In the filling the adhesive receiving groove with the adhesive, the adhesive may be filled to a position at which a guide groove is formed in an outer surface of the adhesive receiving groove.

The cover member may be bonded to the sleeve such that an outer peripheral surface of the coupling part is bonded to an outer surface of the adhesive receiving groove of the sleeve.

The method may further include hardening the adhesive filling the adhesive receiving groove after the coupling of the cover member to the sleeve.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIG. 2 is an enlarged view showing part A of FIG. 1;

FIG. 3 is a partially cut-away exploded perspective view showing a sleeve and a cover member included in a spindle motor according to an embodiment of the present invention; and

FIGS. 4 through 7 are views describing a method of manufacturing a spindle motor according to an embodiment of the present invention.

### DETAILED DESCRIPTION OF THE INVENTION

Embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

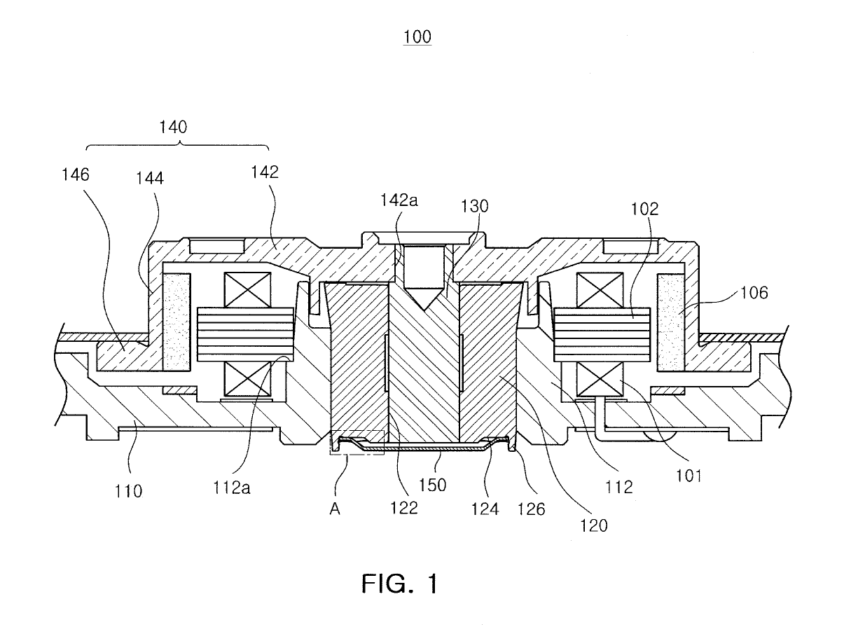

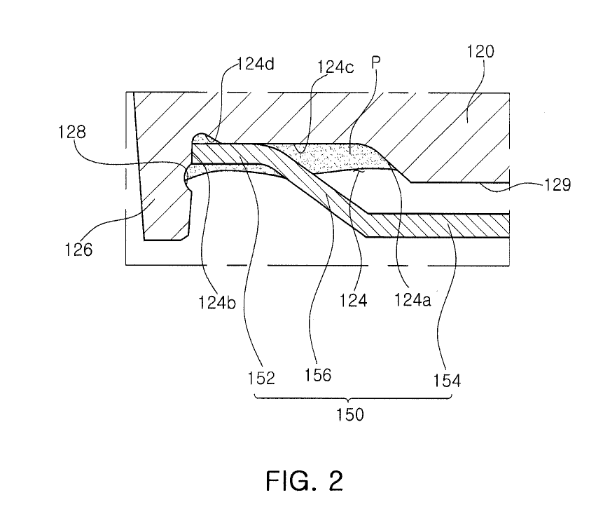

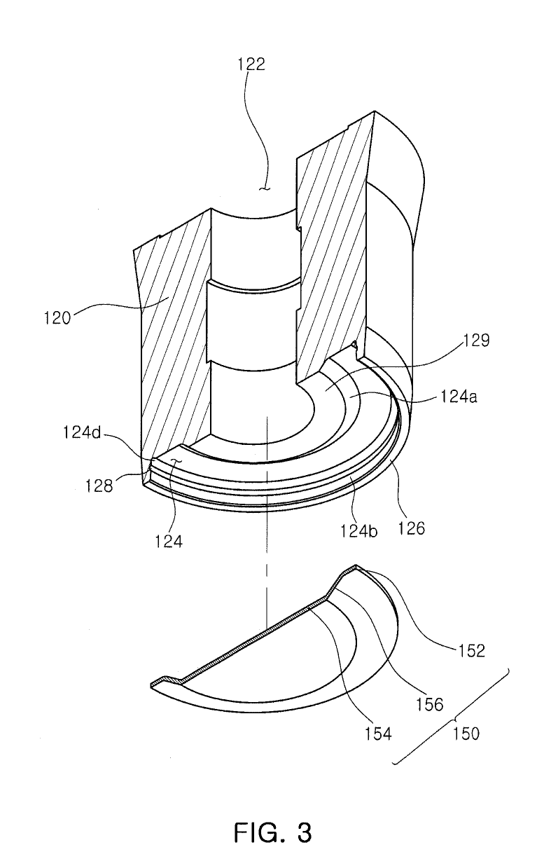

FIG. 1 is a cross-sectional view schematically showing a spindle motor according to an embodiment of the present invention; FIG. 2 is an enlarged view of part A of FIG. 1; and FIG. 3 is a partially cut-away exploded perspective view showing a sleeve and a cover member included in a spindle motor according to an embodiment of the present invention.

Referring to FIGS. 1 through 3, a spindle motor 100 according to an embodiment of the present invention may include a base member 110, a sleeve 120, a shaft 130, a rotor hub 140, and a cover member 150.

Here, terms with respect to directions will be defined. As viewed in FIG. 1, an axial direction refers to a vertical direction, that is, a direction from a lower portion of the shaft 130 toward an upper portion thereof or a direction from the upper portion of the shaft 130 toward the lower portion thereof; a radial direction refers to a horizontal direction, that is, a direction from an outer peripheral surface of the rotor hub 140 toward the shaft 130 or from the shaft 130 toward the outer peripheral surface of the rotor hub 140; and a circumferential direction refers to a rotation direction along the outer peripheral surface of the rotor hub 140.

The base member 110 may include a protrusion part 112 having the sleeve 120 installed therein. The protrusion part 112 may be protruded upwardly in the axial direction and have a hollow cylindrical shape. In addition, the sleeve 120 may be insertedly installed in the protrusion part 112.

Meanwhile, the protrusion part 112 may include a stator core 102 installed on an outer peripheral surface thereof, and the stator core 102 has a coil 101 wound therearound. That is, the stator core 102 may be fixedly installed by an adhesive in a state in which it is seated on a seat surface 112a formed on the outer peripheral surface of the protrusion part 112.

The sleeve 120 may rotatably support the shaft 130. In addition, the sleeve 120 may be inserted into and fixed to the protrusion part 112 as described above. That is, an outer peripheral surface of the sleeve 120 may be bonded to an inner peripheral surface of the protrusion part 112 by an adhesive.

However, without being limited thereto, the sleeve 120 may be press-fitted into the protrusion part 112 or be bonded to the protrusion part 112 by welding.

Further, the sleeve 120 may include a through-hole 122 formed therein such that the shaft 130 may be insertedly disposed therein. That is, the sleeve 120 may have a hollow cylindrical shape.

Meanwhile, in the case in which the shaft 130 is insertedly disposed in the sleeve 120, an inner peripheral surface of the sleeve 120 and an outer peripheral surface of the shaft 130 may be spaced apart from each other by a predetermined interval to thereby form a bearing clearance therebetween. This bearing clearance may be filled with a lubricating fluid.

In addition, the sleeve 120 may include an adhesive receiving groove 124 formed in a lower end portion thereof. Further, the sleeve 120 may include an extension wall part 126 formed at an edge of a lower surface thereof, and the extension wall part 126 is extended downwardly in the axial direction.

That is, an inner surface of the extension wall part 126 forms an outer wall of the adhesive receiving groove 124. That is, the adhesive receiving groove 124 may be depressed upwardly from the lower surface 129 of the sleeve 120 in the axial direction, the extension wall part 126 may be formed at an outer side of the adhesive receiving groove 124 in the radial direction, that is, at the edge of the lower surface of the sleeve 120.

In addition, an inner surface 124a of the adhesive receiving groove 124 may be inclined.

Further, a guide groove 128 for guiding an amount of the adhesive P may be formed in an outer surface 124b of the adhesive receiving groove 124, that is, an inner peripheral surface of the extension wall part 126.

A detailed description of the adhesive receiving groove 124, the extension wall part 126, and the guide groove 128 of the sleeve 120 will be provided below.

The shaft 130 may be rotatably installed in the sleeve 120. That is, the shaft 130 may be insertedly disposed in the through-hole 122 of the sleeve 120.

Further, the shaft 130 may have the rotor hub 140 fixedly installed on an upper end portion thereof. That is, the shaft 130 may be coupled to the rotor hub 140 so as to rotate together with the rotor hub 140 at the time of rotation of the rotor hub 140.

Meanwhile, the rotor hub 140 may include a body 142 provided with an mounting hole 142a into which the shaft 130 is inserted, a magnet mounting part 144 extended downwardly from an edge of the body 142 in the axial direction, and a seating part 146 extended from an distal end of the magnet mounting part 144 in the outer radial direction.

In addition, the magnet mounting part 144 may have a driving magnet 106 installed on an inner surface thereof, and the driving magnet 106 is disposed to face a front end of the stator core 102 having the coil 104 wound therearound.

Meanwhile, the driving magnet 106 may have an annular ring shape and be a permanent magnet generating magnetic force having a predetermined strength by alternately magnetizing an N pole and an S pole in the circumferential direction.

Here, the rotational driving of the rotor hub 140 will be schematically described. When power is supplied to the coil 104 wound around the stator core 102, a driving force capable of rotating the rotor hub 140 is generated by electromagnetic interaction between the driving magnet 106 and the stator core 102 having the coil 104 wound therearound.

Therefore, the rotor hub 140 rotates, such that the shaft 140 to which the rotor hub 140 is fixedly coupled may rotate together with the rotor hub 140.

Meanwhile, the cover member 150 may include a coupling part 152 installed on the lower end portion of the sleeve 120 and inserted into and coupled to the adhesive receiving groove 124.

In addition, the cover member 150 may serve to prevent the lubricating fluid from being leaked to the lower end portion of the sleeve 120.

Meanwhile, the cover member 150 may include a disk part 154 having a disk shape, an inclined part 156 extended to be inclined upwardly from the disk part 152, and the coupling part 152 extended from the inclined part 156 in the outer radial direction.

In addition, the coupling part 152 may be disposed to be immersed in the adhesive P filling the adhesive receiving groove 124.

That is, the adhesive receiving groove 124 may be filled with the adhesive P before the sleeve 120 and the cover member 150 are coupled to each other. In addition, the adhesive receiving groove 124 may have a depth allowing the coupling part 152 to be insertedly disposed in an inner portion thereof. Therefore, in the case in which the cover member 150 is installed on the sleeve 120, the coupling part 152 may be insertedly disposed in the inner portion of the adhesive receiving groove 124 to thereby be immersed in the adhesive P.

Further, when the adhesive P fills the adhesive receiving groove 124, the adhesive P may be filled to a position at which the guide groove 128 is formed in the inner peripheral surface of the extension wall part 126.

Meanwhile, an upper surface of the coupling part 152 may be closely adhered to a ceiling surface 124c of the adhesive receiving groove 124, and an outer peripheral surface of the coupling part 152 may be closely adhered to the inner surface of the extension wall part 126, that is, the outer surface 124b of the adhesive receiving groove 124.

Meanwhile, the ceiling surface 124c of the adhesive receiving groove 124 may include a depression groove 124d formed in order to improve bonding strength of the coupling part 152.

In addition, in the case in which the cover member 150 is installed on the sleeve 120, a lower surface of the coupling part 152 may be disposed at a position higher than that of the lower surface 129 of the sleeve 120 as shown in FIG. 2.

In other words, in the case in which the cover member 150 is installed on the sleeve 120, the adhesive receiving groove 124 may be formed to have a depth at which the lower surface of the coupling part 152 and the lower surface 129 of the sleeve 120 may be disposed to be stepped from each other.

In addition, the inclined part 156 of the cover member 150 may be inclined so as not to interfere with the inner surface 124a of the adhesive receiving groove 124. In addition, the inclined part 156 may have the same inclined degree as that of the inner surface 124a of the adhesive receiving groove 124.

As described above, the cover member 150 is bonded to the sleeve 120 such that the coupling part 152 is insertedly disposed in the adhesive receiving groove 124 in a state in which the adhesive receiving groove 124 is filled with the adhesive P.

Therefore, since a single application of the adhesive P may be required to thereby improve work efficiency.

In other words, the adhesive receiving groove 124 has a depth allowing the coupling part 152 to be insertedly disposed in the inner portion thereof, such that the coupling part 152 may be immersed in the adhesive P filling the adhesive receiving groove 124, whereby the number of application of the adhesive P may be reduced to 1. Therefore, the cover member 150 may be more easily installed on the sleeve 120.

Further, the guide groove 128 is formed in the inner peripheral surface of the extension wall part 126, such that the filling of the adhesive P may be facilitated and the installation of the cover member 150 may proceed upon confirmation of the amount of the adhesive P with the naked eye.

Therefore, the amount of the adhesive P may be managed, such that contamination due to the adhesive P may be reduced.

In addition, the coupling part 152 is disposed to be immersed in the adhesive P filling the adhesive receiving groove 124, such that coupling strength between the cover member 150 and the sleeve 120 may be improved.

Hereinafter, a method of manufacturing a spindle motor according to the embodiment of the present invention will be described with reference to the accompanying drawings. Meanwhile, the same reference numerals will be used to describe the same components as those of the spindle motor 100 according to the above-described embodiment of the present invention.

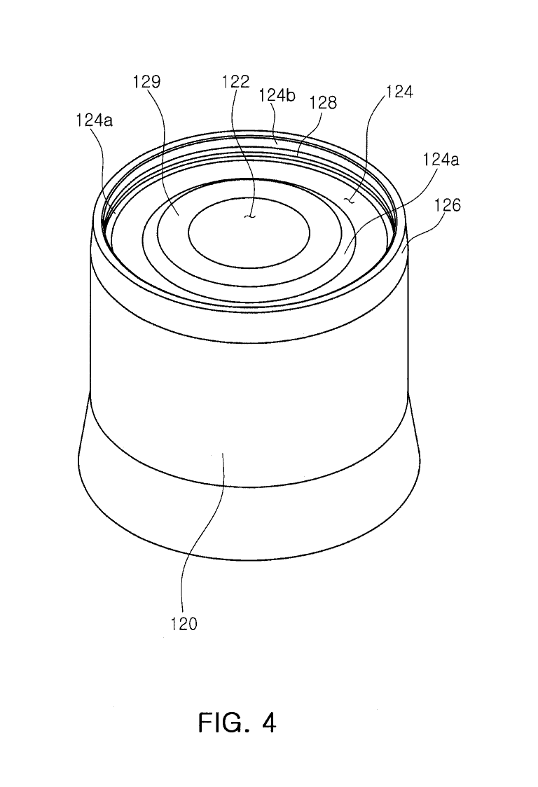

FIGS. 4 through 7 are views describing a method of manufacturing a spindle motor according to an embodiment of the present invention.

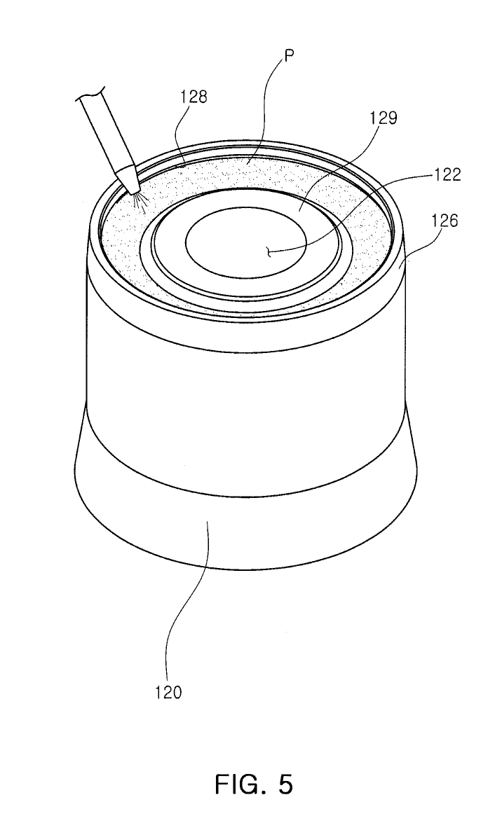

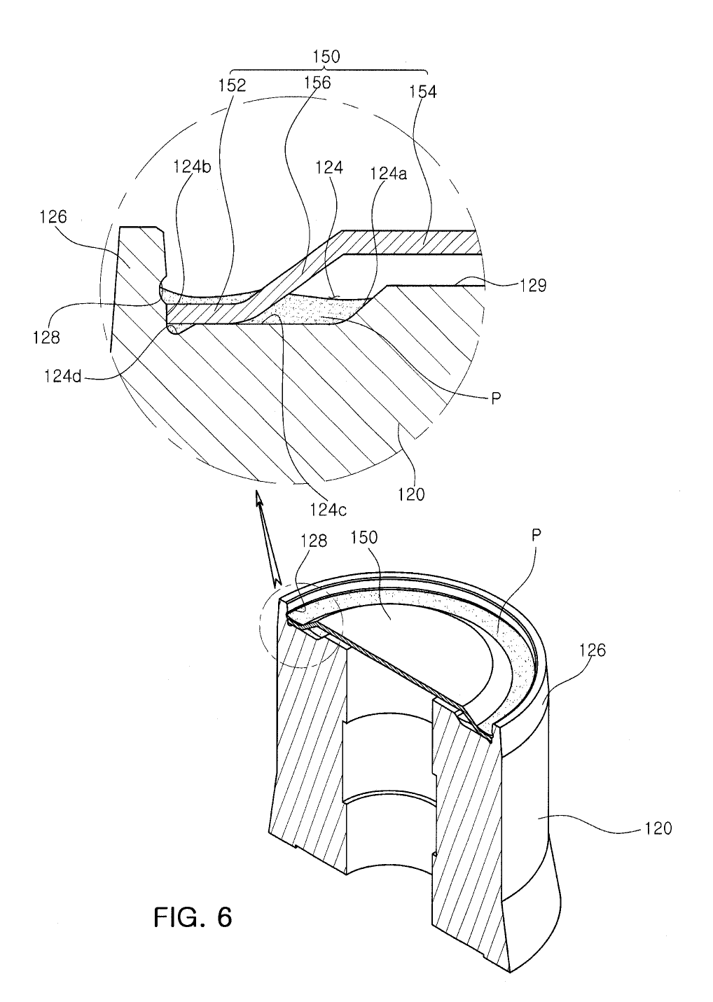

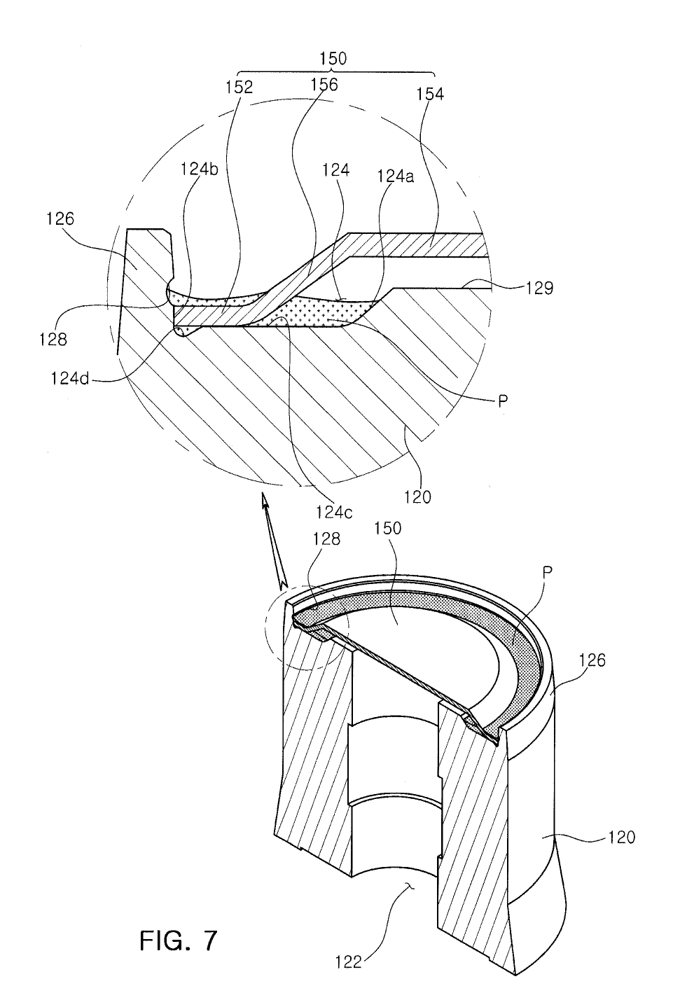

More specifically, FIG. 4 is a view describing a process of preparing a sleeve; FIG. 5 is a view describing a process of filling an adhesive receiving groove with an adhesive; FIG. 6 is a view describing a process of installing a cover member on a sleeve; and FIG. 7 is a view describing a process of hardening the adhesive.

First, referring to FIG. 4, the sleeve 120 is prepared so that the lower surface of the sleeve 120 having the adhesive receiving groove 124 formed therein is disposed to be directed upwardly. That is, the sleeve 120 is prepared in a state in which it is overturned such that the adhesive receiving groove 124 is directed upwardly.

Next, as shown in FIG. 5, the adhesive P is inserted into the adhesive receiving groove 124. At this time, the adhesive P is inserted into the adhesive receiving groove 124 up to the guide groove 128 (See FIG. 6) formed in the inner peripheral surface of the extension wall part 126 of the sleeve 120.

As described above, an inserted amount of the adhesive P may be managed by the guide groove 128.

Next, as shown in FIG. 6, the cover member 150 is installed on the sleeve 120. At this time, the coupling part 152 of the cover member 150 is immersed in the adhesive P filling the adhesive receiving groove 124.

In addition, the cover member 150 is installed on the sleeve 120 such that the upper surface of the coupling part 152 is closely adhered to the ceiling surface 124c of the adhesive receiving groove 124 and the outer peripheral surface of the coupling part 152 is closely adhered to the outer surface 124b of the adhesive receiving groove 124.

As described above, the coupling part 152 is insertedly disposed in the adhesive receiving groove 124, whereby the installation position of the cover member 150 may be stably maintained.

In addition, the cover member 150 is bonded to the sleeve 120 such that the coupling part 152 of the cover member 150 is insertedly disposed in the inner portion of the adhesive receiving groove 124 in a state in which the adhesive receiving groove 124 is filled with the adhesive P fills, and accordingly, the number of application of the adhesive P is reduced, whereby manufacturing efficiency may be improved.

That is, a process of primarily applying the adhesive before the cover member 150 is installed and then secondarily applying the adhesive after the cover member 150 is installed is replaced with a process of filling the adhesive receiving groove 124 with the adhesive P, whereby the manufacturing efficiency may be improved.

Further, the guide groove 128 is formed in the inner peripheral surface of the extension wall part 126, such that the filling of the adhesive P may be facilitated and the installation of the cover member 150 may proceed upon confirmation of the amount of the adhesive P with the naked eye.

Therefore, the amount of the adhesive P may be managed, such that contamination due to the adhesive P may be reduced.

In addition, the coupling part 152 is disposed to be immersed in the adhesive P filling the adhesive receiving groove 124, such that coupling strength between the cover member 150 and the sleeve 120 may be improved.

Further, the method of manufacturing the spindle motor according to the embodiment of the present invention may further include, after bonding the cover member 150 to the sleeve 120, hardening the adhesive filling the adhesive receiving groove 124.

That is, the cover member 150 is fixed to the sleeve 120 by inserting the coupling part 152 of the cover member 150 into the inner portion of the adhesive receiving groove 124 and then hardening the adhesive P by heat and/or light.

As described above, the cover member 150 is adhered to the sleeve 120 such that the coupling part 152 is insertedly disposed in the adhesive receiving groove 124 in a state in which the adhesive receiving groove 124 is filled with the adhesive P.

Therefore, since a single application of the adhesive P may be required to improve work efficiency.

In other words, the adhesive receiving groove 124 has a depth allowing the coupling part 152 to be insertedly disposed in the inner portion thereof, such that the coupling part 152 may be immersed in the adhesive P filling the adhesive receiving groove 125, whereby the number of application of the adhesive P may be reduced to 1. Therefore, the cover member 150 may be more easily installed on the sleeve 120.

Further, the guide groove 128 is formed in the inner peripheral surface of the extension wall part 126, such that the filling of the adhesive P may be facilitated and the installation of the cover member 150 may proceed upon confirmation of the amount of the adhesive P with the naked eye.

Therefore, the applied amount of the adhesive P may be managed, such that contamination due to the adhesive P may be reduced.

As set forth above, according to embodiments of the present invention, the cover member is installed on the sleeve such that the coupling part thereof is insertedly disposed in the adhesive receiving groove in a state in which the adhesive receiving groove is filled with the adhesive, such that the number of application of the adhesive is reduced to 1, whereby work efficiency may be improved.

In other words, the adhesive receiving groove has a depth allowing the coupling part to be insertedly disposed in the inner portion thereof, such that the coupling part may be immersed in the adhesive filling the adhesive receiving groove, whereby a single application of the adhesive may be performed. Therefore, the cover member may be more easily installed on the sleeve.

Further, the guide groove is formed in the inner peripheral surface of the extension wall part, such that the filling of the adhesive may be facilitated and the installation of the cover member may be performed while the amount of the adhesive is confirmed with the naked eye. Therefore, the applied amount of the adhesive may be managed, such that contamination due to the adhesive may be reduced.

In addition, the coupling part is disposed to be immersed in the adhesive filling the adhesive receiving groove, such that coupling strength between the cover member and the sleeve may be improved.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a sleeve rotatably supporting a shaft and having an adhesive receiving groove formed in a lower end portion thereof; and
a cover member installed on the lower end portion of the sleeve and having a coupling part insertedly coupled to the adhesive receiving groove,
wherein the coupling part is disposed so as to be immersed in an adhesive filling the adhesive receiving groove.

2. The spindle motor of claim 1, wherein the cover member includes:
a disk part having a disk shape;
an inclined part extended to be inclined upwardly from the disk part; and
the coupling part extended from the inclined part in an outer radial direction.

3. The spindle motor of claim 2, wherein the sleeve includes an extension wall part formed at an edge of a lower surface thereof, the extension wall part contacting an outer peripheral surface of the coupling part.

4. The spindle motor of claim 2, wherein the adhesive receiving groove has a depth allowing the coupling part to be insertedly disposed in an inner portion thereof.

5. The spindle motor of claim 2, wherein an inner surface of the adhesive receiving groove is inclined so as to correspond to the inclined part.

6. The spindle motor of claim 2, wherein the adhesive receiving groove includes a guide groove formed in an outer surface thereof, the guide groove guiding amount of the adhesive.

7. A method of manufacturing a spindle motor, the method comprising:
preparing a sleeve such that a lower surface of the sleeve having an adhesive receiving groove formed therein is disposed to be directed upwardly;
filling the adhesive receiving groove with an adhesive; and
bonding a cover member to the sleeve such that a coupling part of the cover member is immersed in the adhesive filling the adhesive receiving groove.

8. The method of claim 7, wherein, in the filling of the adhesive receiving groove with the adhesive, the adhesive is filled to a position at which a guide groove is formed in an outer surface of the adhesive receiving groove.

9. The method of claim 7, wherein the cover member is bonded to the sleeve such that an outer peripheral surface of the coupling part is bonded to an outer surface of the adhesive receiving groove of the sleeve.

10. The method of claim 7, further comprising hardening the adhesive filling the adhesive receiving groove after the bonding of the cover member to the sleeve.
